(19) United States
(12) Patent Application Publication
(10) Pub. No.: US 2014/0049246 A1
(43) Pub. Date: Feb. 20, 2014

(54) POWER SUPPLY ARRANGEMENT WITH A TRANSFORMER HAVING A TRANSFORMER CORE WITH LEGS ARRANGED IN A POLYGON

(71) Applicant: AEG POWER SOLUTIONS B.V., Zwanenburg (NL)

(72) Inventors: Gladwyn De Vidts, Lippstadt (DE); Peter Wallmeier, Lippstadt (DE); Christian Ferber, Mohnesee (DE)

(73) Assignee: AEG POWER SOLUTIONS B.V., Zwanenburg (NL)

(21) Appl. No.: 13/764,962

(22) Filed: Feb. 12, 2013

(30) Foreign Application Priority Data
Aug. 16, 2012 (EP) 12 180 740.8

(51) Int. Cl. H01F 38/00; H01F 30/12

(52) U.S. Cl. CPC H01F 38/00; H01F 30/12
USPC 323/355; 336/5

(57) ABSTRACT

Power supply arrangement with first transformer (T1), having transformer core (K) with legs (K1) and yokes (K2) connecting these legs. Legs (K1) and yokes (K2) are arranged in geometric shape of a cylinder. The cylinder has first polygon as base surface and second polygon as surface opposite. The yokes (K2) are arranged along edges of first polygon and along edges of second polygon. Legs (K1) are arranged along edges of an outer surface of the cylinder. Primary windings and secondary windings (T1.1, T1.2, T1.3) arranged on legs (K1) of the transformer core. Secondary windings (T1.1, T1.2, T1.3) have three terminals (A), including a neutral conductor terminal and two phase conductor terminals. Phase conductor terminals of the secondary windings (T1.1, T1.2, T1.3) are mechanically and electrically connected to a first electrically conductive support (L), having an outer end, the outer end of the first carrier (L) are located outside the cylinder.

This application claims priority to EP 12 180 740.8 filed on Aug. 16, 2012.

### BACKGROUND OF THE INVENTION

The present invention relates to a power-supply arrangement with a first transformer, having a transformer core. The transformer core has legs and yokes connecting these legs. The legs and yokes are arranged in the geometric shape of a cylinder and the cylinder has a first polygon as base surface and a second polygon as top surface, wherein the yokes are arranged along edges of the first polygon and along edges of the second polygon and the legs are arranged along the edges of a surface of the cylinder, and with primary windings and secondary windings arranged on the legs of the transformer.

A power supply having such a transformer is known, for example, from the document WO 00/25327 A1. The first and the second polygon are isosceles triangles.

It should be noted that the term cylinder is in this application is not limited to a straight circular cylinder, which is frequently associated exclusively with the term cylinder. A cylinder according to the general definition for the present application (see www.wikipedia.de) is delimited by two parallel flat surfaces (base surface and top surface) and a jacket or cylinder surface, which is formed by parallel lines. In other words, the cylinder is produced by displacing a flat surface or a curve along a straight line, which is not located in this plane. When the straight lines are perpendicular to the base surface and top surface, this is referred to as a straight cylinder in the general definition applying to this application.

The transformer described in the aforementioned document is suitable and configured for transmitting electrical energy from a primary three-phase AC power system to a secondary three-phase AC system or vice versa. It has a compact design, which is particularly advantageous for applications that require a small footprint.

Furthermore, power supply arrangements are known from various published patent applications by the applicant, AEG Power Solutions BV, which are particular suitable and configured for supplying power to polysilicon reactors, which are operated for vapor deposition (CVD) of silicon derived from trichlorosilane on silicon rods with the Siemens process. The power supplies described therein provide on the secondary side, i.e. on the reactor side, at least temporarily high currents of 1000-5000 A, in particular of 3000 A, which flow through the silicon rods to heat the silicon rods

These high currents require electrical connections between the reactor having cross-sections of 500 mm² to 3000 mm², in particular of 1500 mm². The electrical connections are typically made of copper, which can pose a problem in times of rising costs and scarcity of copper.

In the conventional power supply arrangements known to date—as far as these are state-of-the-art—, power controllers are arranged in cabinets, which are placed in one or two rows adjacent to a transformer of the power supply arrangement. The arrangement can result in long wiring paths at the secondary side of the transformer.

The designers of power supply arrangements for the manufacture of polysilicon are interested in having the lines as short as possible to save material.

Accordingly, it has already previously been contemplated to arrange the power supply arrangements underneath a polysilicon reactor to shorten the wiring paths. These measures were already sufficient to reduce the required space for the power supply arrangement and the material required for the connections between the components of the arrangement and/or the arrangement and the reactor. However, further optimization would still be beneficial. One approach includes the use of an above-described power supply arrangement with a transformer having a cylindrical transformer core.

### BRIEF SUMMARY OF THE INVENTION

Based on the aforedescribed power supply arrangement with a transformer with a cylindrical transformer core, an person of skill in the development and design of power supply arrangements for polysilicon reactors was now faced with the task of improving a power supply arrangement of the aforedescribed type so that it could be optimized for supplying power to polysilicon reactors.

The object is attained with the invention in that the secondary windings have at least three terminals, including a neutral terminal and two phase conductor terminals,
each of the external phase conductor terminals of the secondary windings is mechanically and electrically connected to a corresponding first electrically conductive carrier, which has an outer end, and
the outer ends of the first carrier are located outside the cylinder and thus outside of the first transformer.

Preferably, the terminals of the secondary windings are also located outside the cylinder.

The known advantage of the compact, space-saving embodiment of the transformer is combined by the invention with an optimized adaptation of the external shape of the power supply arrangement to the outer shape of a polysilicon reactor. In addition, material can be saved because the secondary circuit of the transformer can then be arranged directly on the outer side of the transformer. The paths between the terminals of the secondary windings can thus be shortened. When loads, for example a polysilicon reactor, are arranged above the power supply arrangement, the distances between the secondary circuit of the transformer and the loads can be shortened compared to the state of the art. The first carriers exit from the side of the transformer. The terminals of the secondary windings are then readily accessible from the outside.

The first carriers preferably exit the transformer at locations where the secondary windings that are connected to the terminals of the carrier protrude from the cylinder described by the transformer core. Unlike with conventional Delta transformers, the terminals of all secondary windings do not exit on a single side of the transformer. Rather, the first carriers are located on all sides of the transformer.

It has been found for power supply arrangements according to the invention for three-phase AC current systems, that cylinders with isosceles triangles as the basic or top surfaces are particularly suited for defining the position of the legs and yokes of the transformer core and the windings. Such transformers are in this application also referred to as Delta transformers.

The first carrier may have a cross section of 500 mm² to 3000 mm², in particular of 1500 mm².

According to the invention, circuit carriers may be attached to the first carriers, in particular to the outer ends of the first carriers. The first carriers may support the circuit carrier entirely or partially. Alternatively, the first carriers may not experience a mechanical load from the circuit carriers. The transformer may include one or more holding means, on which the transformer core is arranged, and which also completely or partially, directly or indirectly support the circuit carrier. The holding means may include a frame on which the transformer rests and which advantageously also holds and/or supports the circuit carriers.

The power supply arrangement may include power controllers. An input of each power controller may be electrically connected to a phase terminal of one of the secondary windings by interconnecting one of the first carriers. Furthermore, one of the power controllers, several of the power controllers or all of power controllers may be arranged on the circuit carriers.

The outputs of those power controllers, whose inputs are connected to the phase conductor terminals of one of the secondary windings, may be electrically connected at one point. These power controllers are preferably arranged on one circuit carrier, or on two adjacent circuit carriers.

The power supply arrangement may comprise a control device. This control device may be suitable and configured for operating the power controllers in a voltage sequence control.

The circuit carriers have at least one substantially flat surface. Preferably, the circuit carrier is a plate. The circuit carriers are preferably entirely or partially made of an electrical insulator.

According to the invention, each circuit board with the at least one flat surface may be arranged parallel to the legs and parallel to two yokes of the transformer core.

At least one additional leg may be arranged between the flat surface of one of the circuit carriers and the legs and yokes parallel thereto.

Alternatively, no additional leg may be arranged between the flat surface of one of the circuit carriers and the leg and yokes parallel thereto.

The inputs of all power controllers arranged on one of the circuit carriers may be connected to the phase conductor terminals of one of the secondary windings. A corresponding circuit carrier, on which the power controllers connected to the phase conductor terminals of the secondary winding are arranged, may then be associated with each secondary winding.

Likewise, two circuit carriers may be associated with each secondary winding, wherein the power controllers connected to the phase conductor terminals of the secondary winding may be arranged on one of the two circuit carriers. These circuit carriers may carry exclusively the power controllers connected to the terminals of a secondary winding.

The inputs of a first portion of the power controllers arranged on one of the circuit carriers may be connected to the phase conductor terminals of a first of the secondary windings, and the inputs of a second portion of the power controllers arranged on one of the circuit carriers may be connected to phase conductor terminals of a second of the secondary windings.

Advantageously, terminals of the primary windings of the first transformer may be routed into an internal space of the first transformer which is not filled by the transformer core and windings of the first transformer. This provides a simple separation between the secondary-side terminals and the primary-side terminals.

Windings of an additional transformer may be arranged on the transformer core of the first transformer. The windings of the first transformer and of the additional transformer may then be arranged in superpositioned or adjacent areas on the legs of the transformer core. Additional electrically conductive carriers, which entirely or partially hold and/or support the first and/or additional circuit carriers on which power controllers are disposed, may be connected to the phase conductor terminals of secondary windings of the additional transformer.

The power supply arrangement may include at least one additional transformer, which is constructed like the first transformer, wherein electrically conducting carriers, which entirely or partially hold and/or support the first and/or additional circuit carriers on which power controllers are disposed, are connected to the phase conductor terminals of secondary windings of the additional transformer.

When a power supply arrangement has several transformers, these may be stacked. The legs of the transformers may be aligned with each other.

A free space which is suitable and configured for the passage of electrical lines through the transformer(s) may exist between the windings of the first transformer and/or the additional transformer(s). For example, lines of a second power supply arrangement which is suitable and configured to supply a silicon reactor with an intermediate voltage may be routed through this free space.

The terminals of the primary windings to which connecting lines may be routed through the free space may also protrude into this space.

### BRIEF DESCRIPTION OF THE DRAWING

An exemplary embodiment of the invention will be described in more detail with reference to the drawing, which shows a schematic diagram

FIG. 1 shows a power supply arrangement according to the invention in a bird's eye view,

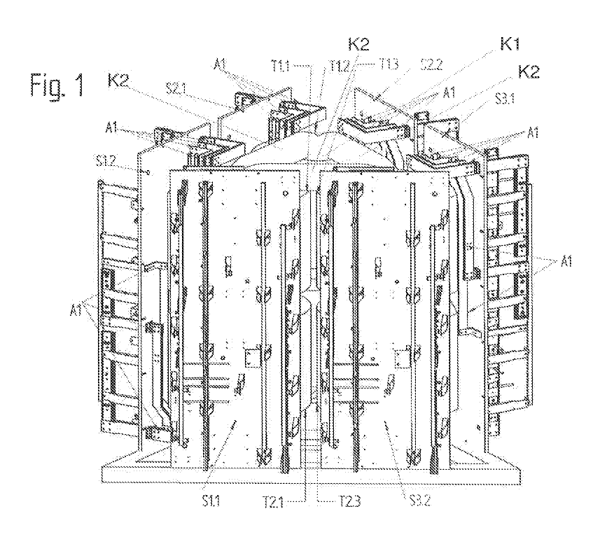

FIG. 2 shows the power supply arrangement in a plan view,

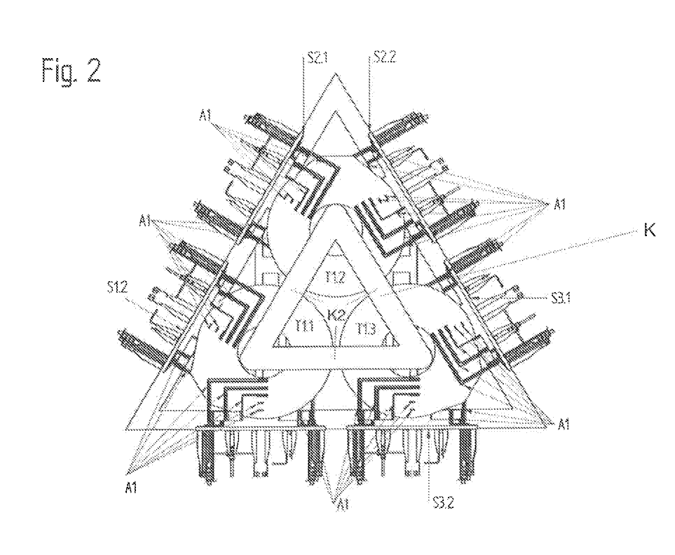

FIG. 2a shows a detail of FIG. 2 on an enlarged scale, and

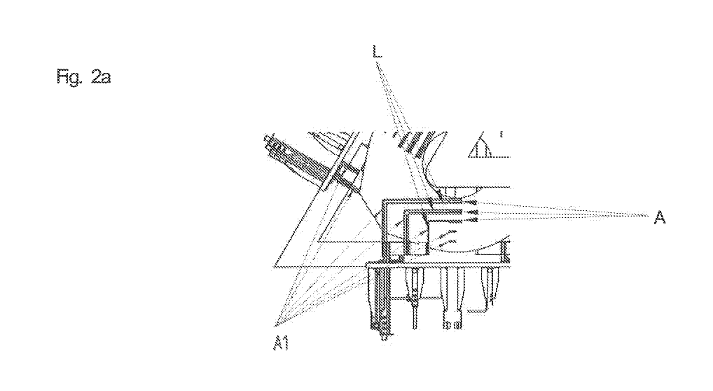

FIG. 3 shows the power-supply arrangement in a front view.

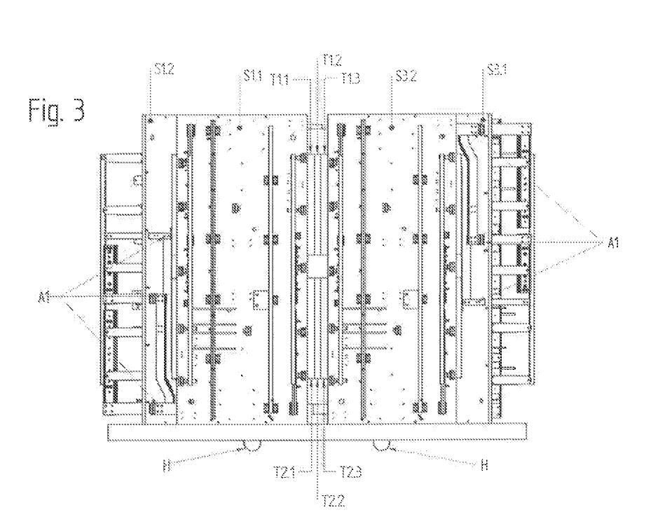

### DETAILED DESCRIPTION OF THE INVENTION

The power supply arrangement according to the invention has two transformers T1, T2. The transformers T1, T2 have primary windings and secondary windings T1.1 to T2.3, which are arranged on a common transformer core K. The transformer core K has legs K1 and yokes K2 which are arranged in the geometric shape of a straight cylinder with a triangle as a base surface and a triangle as a top surface. The yokes K2 are arranged along the edges of the base surface and the top surface. The legs K1 are arranged along the edges of an outer surface of the cylinder.

The transformers T1, T2 are three-phase AC current transformers, each having three primary windings and three secondary windings.

A total of four windings are arranged on a leg K1, namely a primary winding of the first transformer T1, a secondary winding of the first transformer T1, a primary winding of the second transformer T2, and a secondary winding of the second transformer T2.

The primary windings and secondary windings of the first transformer T1 are arranged in a first region, and the primary windings and secondary windings of the second transformer are arranged in a second region.

The first region and the second region are arranged on top of one another.

The secondary windings T1.1 to T2.3 of transformers T1, T2 are wound from copper tapes, so that the secondary windings may be in the form of a tape having a small thickness and a large width of the tapes with a cross section of 1500 mm².

The secondary windings T1.1 to T2.3 of the transformers T1, T2 have several terminals A, a neutral conductor terminal and several phase conductor terminals. One of the phase conductor terminals and the neutral conductor terminal are preferably provided on one end of each secondary winding T1.1 to T2.3. The other phase conductor terminals are respective center taps of the secondary windings.

The terminals A, i.e. the phase conductor terminals and the neutral conductor terminal of the secondary windings to T1.1 T2.3, are connected to electrical conductors L made of a bending-resistant metal, preferably copper. These bending-resistant conductors L also have a cross section of 1500 mm². The bending-resistant conductors L protrude laterally from the transformers and serve as carriers, which partially hold plate-shaped circuit carriers S1.1 to S3.1 arranged along the legs of the transformer core. The conductors L, hereinafter also referred to as carriers L, and the terminals A are denoted in the Figures with A1. The Figures show several terminals A that are not connected to a conductor L, but could be connected to other conductors L.

Power controllers are mounted on the circuit carriers S1.1 to S3.1, wherein a first terminal of a power controller is connected via a respective one of the carriers L to a phase conductor terminal of a secondary winding. Second terminals, namely output-side terminals of the power controllers, are connected with one another via conductors at a single point, which point is connected to an output terminal of the power supply arrangement according to the invention.

In addition to the power controllers, additional elements and components are arranged on the circuit carriers S1.1 to S3.1. These may be used to control the power controllers, to produce ignition pulses of converter valves of the power controllers, for example thyristors, IGBTs, or other controllable switches, and the like. The elements and components arranged on the circuit carriers are not or only partially shown in the Figures.

The power controllers connected downstream of a secondary winding T1.1 to T2.3 are arranged on two circuit carriers disposed adjacent to this secondary winding, so that all phase conductor terminals of the secondary windings having short carriers are connected to the downstream power controller.

The circuit carriers S1.1 to S3.1, which carry power controllers connected to the phase conductor terminals of a secondary winding T1.1 to T2.3, such as the circuit carriers S2.1 and S2.2 with respect to the secondary winding T1.2, are arranged in planes that intersect at an angle of 50 to 70°, preferably 60°.

Two circuit carriers S1.1 to S3.1, for example S1.2 and S2.1, are each arranged in a plane, wherein power controllers are arranged on the circuit carriers S1.1 to S3.1 arranged in a plane and connected to various secondary windings T1.1 to T2.3 of the first region and the second region, respectively.

Power controllers connected to secondary windings T1.1 to T2.3 of superpositioned regions can be arranged collectively on a circuit carrier S1.1 to S3.1. For example, the circuit carrier S2.1 carries power controllers connected to terminals of the secondary winding T1.2 as well as power controllers connected to terminals of the secondary winding T2.2.

Two respective circuit carriers S1.1 to S3.1 are disposed on each side of the cylinder spanned by the transformer core K parallel to two legs K1 and two yokes K2 connecting these legs K1, and are adjacent to these legs K1 and yokes K2 such that no other leg K1 and no other yoke K2 are arranged therebetween.

What is claimed is:

1. A power supply arrangement comprising
a first transformer (T1), having a transformer core (K), the transformer core (K) has legs (K1) and yokes (K2) connecting these legs,
the legs (K1) and yokes (K2) are arranged in the geometric shape of a cylinder and the cylinder has a first polygon as a base surface and a second polygon as a surface opposite the base surface,
the yokes (K2) are arranged along edges of the first polygon and along edges of the second polygon, and the legs (K1) are arranged along the edges of an outer surface of the cylinder and with primary windings and secondary windings (T1.1, T1.2, T1.3) arranged on the legs (K1) of the transformer core,
wherein the secondary windings (T1.1, T1.2, T1.3) have at least three terminals (A), including a neutral conductor terminal and two phase conductor terminals,
all phase conductor terminals of the secondary windings (T1.1, T1.2, T1.3) are mechanically and electrically connected to a respective first electrically conductive support (L) which has an outer end, and
the outer ends of the first carrier (L) are located outside the cylinder.

2. The power supply arrangement according to claim 1, wherein circuit carriers (S1.1 to S3.2) are attached to the first carriers (L).

3. The power supply arrangement according to claim 2, wherein the first carriers (L) carry the circuit carriers (S1.1 to S3.2).

4. The power supply arrangement according to claim 2, wherein the power supply arrangement comprises power controllers, wherein an input of each power controller is electrically connected to a phase conductor terminal of one of the secondary windings through interposition of one of the first carriers (L) and is arranged one of the circuit carriers (S1.1 to S3.2).

5. The power supply arrangement according to claim 4, wherein the outputs of the power controllers, whose inputs are connected to the phase conductor terminals of one of the secondary windings (T1.1, T1.2, T1.3), are electrically connected with one another at a single point.

6. The power supply arrangement according to claim 5, wherein the power supply arrangement comprises a control device which is suitable and configured for operating the power controllers in voltage sequence control.

7. The power supply arrangement according to claim 3, wherein the circuit carriers (S1.1 to S3.2) have at least one substantially flat surface.

8. The power supply arrangement according to claim 7, wherein each circuit board (S1.1 to S3.2) is attached with its flat surface to the first carriers (L) parallel to at least two legs (K1) and parallel to two yokes (K2) of the transformer core (K).

9. The power supply arrangement according to claim 8, wherein at least one additional leg (K1) is arranged between the flat surface of one of the circuit carriers (S1.1 to S3.2) and the yokes (K2) that are parallel to the flat surface.

10. The power supply arrangement according to claim 8, wherein no additional leg (K1) is arranged between the flat surface of one of the circuit carrier (S1.1 to S3.2) and the yokes (K2) are parallel to the flat surface.

11. The power supply arrangement according to claim 3, wherein the inputs of all power controllers arranged on one of the circuit carriers (S1.1 to S3.2) are connected to the phase conductor terminals of one of the secondary windings.

12. The power supply arrangement according to claim 3, wherein the inputs of a first portion of the power controllers arranged on one of the circuit carriers (S1.1 to S3.2) are connected to the phase conductor terminals of a first of the secondary windings (T1.1, T1.2, T1.3) and the inputs of a second portion of the power controllers arranged on one of the circuit carriers (S1.1 to S3.2) are connected to the phase conductor terminals of a second of the secondary windings (T1.1, T1.2, T1.3).

13. The power supply arrangement according to claim 1, wherein the power supply arrangement comprises at least one additional transformer (T2) which is constructed like the first transformer (T1), and additional electrically conductive carriers (L) are connected to the phase conductor terminals of secondary windings of the additional transformer, wherein the additional carriers (L) hold the circuit carriers (S1.1 to S3.2) and/or additional circuit carriers on which power controllers are disposed.

14. The power supply arrangement according to claim 1, wherein a free space, which is suitable and configured to pass electric wires through the transformer(s), is present between the windings of the first transformer (T1) and/or between the windings of the additional transformer(s).

15. The power supply arrangement according to claim 2, wherein circuit carriers (S1.1 to S3.2) are on the outer ends of the first carriers (L).
